(19) United States
(12) Patent Application Publication
(10) Pub. No.: US 2021/0291592 A1
(43) Pub. Date: Sep. 23, 2021

(54) TIRE AND A RUBBER PLY FOR A TIRE

(71) Applicants: THE GOODYEAR TIRE & RUBBER COMPANY, Akron, OH (US); KORDSA TEKNIK TEKSTIL A.S., Izmit / Kocaeli (TR)

(72) Inventors: Raphael Beck, Reichlange (LU); Dirk Lothar Maria van Eck, Rodgau (DE); Olivier Marcel Eugène Durand, Domérat (FR); Sébastien Montet, Michelau (LU); Gary Terence Barrett, Sutton Coldfield (GB); Eric Rossignaud, Villebret (FR); Mehmet Saadettin FIDAN, Izmit/Kocaeli (TR); Hazal ÖZCAN, Izmit/Kocaeli (TR); Neslihan GÜL, Izmit/Kocaeli (TR)

(21) Appl. No.: 17/194,993

(22) Filed: Mar. 8, 2021

Related U.S. Application Data
(60) Provisional application No. 62/990,682, filed on Mar. 17, 2020.

(51) Int. Cl. B60C 9/00; B60C 9/22

(52) U.S. Cl. CPC B60C 9/0042; B60C 2009/0078; B60C 2009/0092; B60C 9/22

(57) ABSTRACT

The present invention is directed to a rubber ply for a tire, the rubber ply comprising pairs of textile cords arranged in parallel in a plane, wherein each cord of the pairs of textile cords comprises two cord plies. The distance between two adjacent pairs of textile cords (dₚ) is at least 5 times larger than the distance between two parallel textile cords (dᵢ) within a pair of textile cords, and wherein the two cord plies in one or more of the textile cords are twisted together in a range from 8 TPI to 12 TPI and have each a density ranging from 500 dtex to 2000 dtex. The present invention is also directed to a tire comprising such a rubber ply which is particularly applicable and beneficial for utilization in motorcycle tires.

This application claims benefit of U.S. Provisional Patent Application Ser. No. 62/990,682, filed on Mar. 17, 2020. The teachings of U.S. Provisional Patent Application Ser. No. 62/990,682 are incorporated herein by reference in their entirety.

### FIELD OF THE INVENTION

This invention relates to a rubber component, in particular a rubber ply for a tire, such as a motorcycle tire, an automobile tire, a truck tire or an aircraft tire. Moreover, the present invention relates to tire comprising such a rubber ply, in particular a tire comprising an overlay ply strip.

### BACKGROUND OF THE INVENTION

Tire performance has significantly improved over the last few decades. The continuous development of better textile cord constructions which can be embedded in rubber materials to make improved composites, such as tires, power transmission belts, and conveyor belts has been a major factor in attaining such improvements in performance. More specifically, better belt plies and overlay plies have proven to be of particular value in the high-performance tire segment. Also paired textile cord constructions have recently been suggested in which two adjacent cords form a pair of cords which may help to improve the weight efficiency of a respective rubber ply component. Despite recent developments in this area of technology significant room for further improvement still remains.

### SUMMARY OF THE INVENTION

A first object of the present invention may be to provide an advanced rubber component including textile cords.

Another object of the present invention may be to provide an advanced rubber ply, in particular carcass ply, comprising textile cords which has a superior stiffness perpendicular to the length of the cords.

Still another object of the present invention may be to provide an advanced rubber ply comprising textile cords which minimizes weight and/or provides a good compromise between the amount of rubber and textile cord material utilized.

Another object of the present invention may be to provide a tire comprising a ply with textile cords, wherein the tire has a higher lateral stiffness.

In a first aspect of the invention a rubber ply for a tire is provided, the rubber ply comprising pairs of textile cords arranged in parallel in a plane. Each cord of the pairs of textile cords comprises two cord plies, wherein the distance between two adjacent pairs of textile cords (dₚ) is at least five times larger than the distance between two parallel textile cords (dᵢ) within a pair of the textile cords, and wherein the two cord plies in one or more of the textile cords are twisted together in a range from 8 twists per inch (TPI) to 12 TPI and have each a (linear) density ranging from 500 dtex to 2000 dtex. The inventors have discovered that such a ply construction is particularly desirable.

In one embodiment, the distance between two adjacent pairs of textile cords (dp) corresponds to (or ranges from) 40% to 300% of a maximum diameter of the cords of said adjacent pairs of textile cords. In other words, the maximum diameter of a cord shall be the largest diameter measurable in a direction perpendicular to the extension of the cord, in particular in case the cord does not have a perfect circular cross section. Such a distance may help to ensure that sufficient rubber is present between the pairs of textile cords such that a sufficient level of tear resistance is provided.

In another embodiment, the distance between two parallel textile cords (di) within a pair of textile cords is smaller than 30%, preferably smaller than 10%, of a maximum diameter of the cords of said pair of textile cords. In another embodiment, the rubber ply comprises a plurality of pairs of textile cords arranged in parallel in a plane and coated, or in other words calendered, on both sides with rubber or rubber sheets so as to embed the plurality of cords within the rubber and/or form the rubber ply. In principle, it is known to the person skilled in the art how to make rubber plies including textile cords or fabrics comprising such cords, in particular in a textile or fabric calendar unit. Rather the specific arrangement of cords within the rubber ply, and the type of cords and/or its properties are within the focus of the present invention.

In another embodiment, the number of textile cords measured in parallel to the plane and perpendicular to a length of the textile cords ranges from 25 ends per inch (EPI) to 40 EPI. In particular, each pair of cords is considered to have two ends, i.e. one end per cord. A pair of cords may be considered to lie in parallel (or in other words flat) in said plane.

In yet another embodiment, the number of textile cords measured in parallel to the plane and perpendicular to a length of the cords ranges from 30 EPI to 38 EPI. These values have been found by the inventors to be most preferable.

In still another embodiment, two cord plies of the textile cords are twisted together in a range from 9 TPI to 11 TPI to form together one cord of a pair of cords. Such a twist factor has been determined to be most desirable.

In still another embodiment, the density of the cord plies is is within the range of 900 dtex to 1450 dtex. This sub-range represents the most preferable linear cord ply density.

In still another embodiment, the textile cords (and the cord plies) are comprised of a polyamide, such as nylon-6,6, nylon-4,6. nylon-6,9, nylon-6,10, nylon 6,12, nylon-6, nylon-11, or nylon-12. In most cases nylon-6,6 is typically preferred. However, other textile materials, such as aramids or polyesters, including polyethylene terephthalate and polyethylene naphthalate can also be used. In some embodiments of this invention hybrid materials, such as various blends of polyamides and blends of polyesters can be utilized.

In yet another embodiment, the distance between two adjacent pairs of textile cords (dₚ) ranges from 0.15 mm to 1.5 mm. In general, such a distance could also be called the “rivet” between two adjacent pairs of cords. This distance has been identified to constitute a good compromise between the lateral density of cords and the amount of rubber still present between the pairs of cords to ensure a sufficient tear strength between the rubber on top and below of the plurality of cords. Even more preferable, the distance between two adjacent pairs of textile cords (dₚ) ranges from 0.2 mm to 1.0 mm. If the distance between two adjacent pairs of textile cords is too small, not enough rubber may penetrate into the region between two pairs, thereby impairing the tear strength of the material. On the other hand, if the distance is too large the re-enforcement effect of the fibers decreases, in particular in parallel to the plane and perpendicular to the direction of extension of the cords.

In another preferred embodiment, the distance between two parallel textile cords (di) within a pair of textile cords is smaller than 0.15 mm. In particular, the distance could also be 0 mm, in other words, the cords within the pair could touch each other. Due to the round shape of the cords there maybe still some rubber material between the cords of a pair despite the cords touching each other.

In still another embodiment, the distance between two parallel textile cords (di) within a pair of textile cords is within the range of 0.05 mm and 0.15 mm. In particular, it may be desirable to provide still some rubber material between the two cords of a pair to reduce the risk of breaking points.

In still another embodiment, the rubber ply is a rubber ply strip having one or more of: a width (w) ranging from 0.5 cm to 2 cm and a thickness (t) ranging from 0.4 mm to 2 mm. Even more preferably, the rubber ply strip has one or more of: a width (w) ranging from 0.5 cm to 1.5 cm and a thickness (t) ranging from 0.5 mm to 1.5 mm. Such a strip (e.g. an overlay strip or in other words overlay ply strip) may be spirally wound on a radially outermost belt ply so as to cover said belt ply (and being arranged radially below a tread of a tire).

In still another embodiment, the weight ratio of rubber to textile cords ranges from 2.3:1 to 1.1:1 in the rubber ply. Even more preferably, the ratio of rubber to textile cords by weight ranges from 2:1 to 1.5:1. This has be found to be a desirable ratio between rubber and textile cords resulting in a good compromise of performance, in particular lateral stiffness, and weight.

In still another embodiment each cord ply has a plurality of yarns and/or filaments.

In a second aspect of the invention, a tire is provided with the tire having a rubber ply comprising pairs of textile cords arranged in parallel in a plane, wherein each cord of a pair of textile cords comprises two cord plies. The distance between two adjacent pairs of textile cords (dₚ) is at least 5 times larger than the distance between two parallel textile cords within a pair of textile cords (dᵢ), and wherein the two cord plies in one or more of the textile cords are twisted together in a range from 8 TPI to 12 TPI and have each a density ranging from 500 dtex to 2000 dtex.

In an embodiment the tire comprises two spaced apart bead portions, a tread portion, a pair of sidewalls extending (essentially radially) from axially outer edges of the tread portion to join the respective bead portion, a carcass, at least one belt ply covering the carcass, and an overlay ply strip spirally arranged in a (circumferential) plane between the tread and the at least one belt ply, wherein the cords are arranged essentially in parallel to the length of the strip.

In a preferred embodiment, the strip is arranged at an angle ranging from 0° to 5° with respect to the equatorial plane (EP) of the tire, such as an angle within the range of 1° to 4°.

In another preferred embodiment, the tire is a motorcycle tire.

In still another embodiment, the tire comprises at least one belt ply comprising a textile cord reinforcement.

In general, the features of different aspects and embodiments of the invention as well as of the present description can be combined with one another.

### BRIEF DESCRIPTION OF THE DRAWINGS

The structure, operation and advantages of the invention will become more apparent upon contemplation of the following description taken in conjunction with the accompanying drawings

FIG. 1 illustrates a schematic cross section of a motorcycle tire comprising a spirally wound overlay ply strip in accordance with an embodiment of the present invention.

FIG. 2 illustrates a schematic cross section of a rubber ply strip in accordance with another embodiment of the present invention.

### DETAILED DESCRIPTION OF THE INVENTION

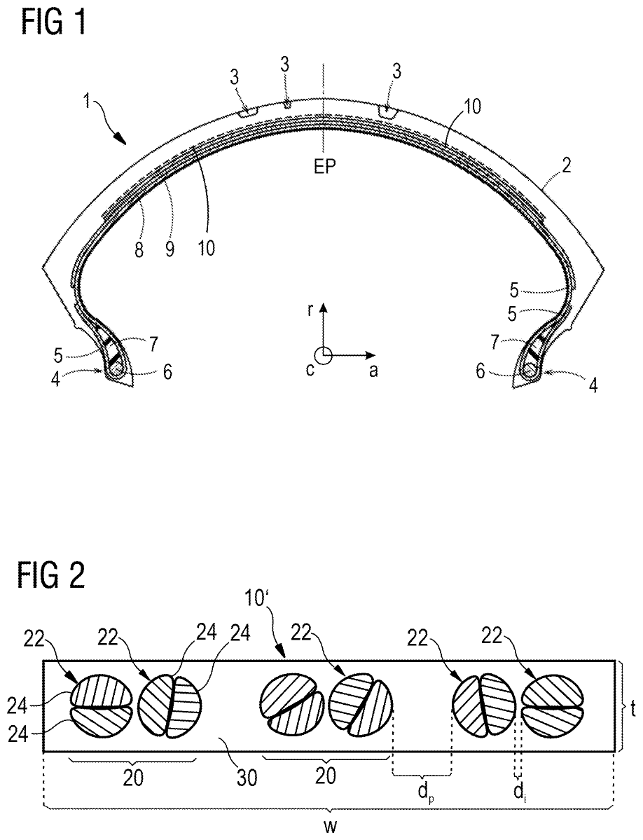

FIG. 1 is a schematic cross-section of a motorcycle tire 1, in accordance with a non-limiting embodiment of this invention. The example tire 1 has a tread 2 having a plurality of grooves 3, a belt structure comprising two belt plies 8, 9, a carcass ply 5, two sidewalls, and two bead regions 4 comprising bead filler apexes 7 and beads 6. The carcass ply 5 includes a pair of axially opposite end portions, each of which is associated with a respective one of the beads 6. Each axial end portion of the carcass ply 5 may be turned up and around the respective bead 6 to a position to anchor each axial end portion. As further shown in FIG. 1, the belt plies 8, 9 are covered by an overlay ply strip 10. In the present example, the overlay ply strip 10 is spirally wound around the belt ply 9 at an angle of less than 5° with respect to the equatorial plane of the tire EP. The overlay ply strip 10 can be spirally wound around the belt ply 9 at an angle of less than 4°, 3°, 2°, or even 1° with respect to the equatorial plane of the tire EP. The overlay strip 10 comprises multiple parallel pairs of textile cords. While the drawing schematically indicates that the ply 10 does not overlap in the axial direction a, such an overlap may be present in practice and in another embodiment. For the sake of better comprehensibility, the axial direction a, the circumferential direction c and the radial direction r have been indicated in FIG. 1 as commonly used in the description of tire geometries.

FIG. 2 shows a detailed schematic cross section of another rubber ply strip 10′ in accordance with another embodiment of the present invention. The example strip has three pairs 20 of cords 22, wherein each cord 22 is made of two cord plies 24. The cord plies 24 are twisted together to form a cord 22. The distance dₚ between two pairs 20 of cords 22 is considerably larger than the distance dᵢ between two cords 22 of one pair 20. In the present example, the distance dₚ is about 7 times larger than the distance dᵢ. The three pairs 20 of cords 22 are embedded over the width w of the strip 10′ which has the thickness t. Due to the paired arrangement of the cords 22, it is possible to provide a relatively thin strip with a limited amount of rubber material.

In particular, each cord 22 comprises or consists of two cord plies 24 twisted together with 8 TPI to 12 TPI, wherein each yarn 24 has a linear density ranging from 500 dtex to 2000 dtex. Preferred examples could for instance have a linear density of 1400 dtex per cord ply 24 at 9.3 TPI (i.e. a 1400/2 9.3×9.3 cord construction). The strip 10′ could for instance have 31 EPI, measured perpendicular to the length of the strip and assuming that the cords 22 are arranged essentially in parallel to the length of the strip 10′ within the strip 10′. In another preferred example, a cord 22 could have the construction 940/2 10.8×10.8 TPI, with 36 EPI measured over the width w of the strip 10′. Each cord 22 of a pair 20 of cords 22 is counted separately when referring to EPI values herein.

In general, rubber material can also be understood herein as an elastomeric material. Any rubber composition commonly used in tire plies or ply strips, in particular in overlay strips, can be used. In particular, the rubber ply can be a cured rubber ply, as common in tire technology.

While certain representative embodiments and details have been shown for the purpose of illustrating the subject invention, it will be apparent to those skilled in this art that various changes and modifications can be made therein without departing from the scope of the subject invention.

What is claimed is:

1. A rubber ply for a tire, the rubber ply comprising pairs of textile cords arranged in parallel in a plane, with each cord of the pairs of textile cords comprising two cord plies, wherein the distance between two adjacent pairs of textile cords (dₚ) is at least five times larger than the distance between two parallel textile cords (dᵢ) within a pair of textile cords, and wherein the two cord plies in one or more of the textile cords are twisted together in a range from 8 twists per inch to 12 twists per inch and wherein the cord plies have a density ranging from 500 dtex to 2000 dtex.

2. The rubber ply of claim 1 wherein the distance between two adjacent pairs of textile cords (dp) corresponds to 40% to 300% of a maximum diameter of the cords of said adjacent pairs of textile cords.

3. The rubber ply of claim 1 wherein the distance between two parallel textile cords (di) within a pair of textile cords is smaller than 30% of a maximum diameter of a cord of said pair of textile cords.

4. The rubber ply of claim 1 wherein the number of textile cords measured in parallel to the plane and perpendicular to a length of the textile cords ranges from 25 EPI to 40 EPI.

5. The rubber ply of claim 3 wherein the number of textile cords measured in parallel to the plane and perpendicular to a length of the cords ranges from 30 EPI to 38 EPI.

6. The rubber ply of claim 1 wherein two cord plies of the textile cords are twisted together in a range from 9 twists per inch to 11 twists per inch to form together a cord.

7. The rubber ply of claim 1 wherein the density is ranging from 900 dtex to 1450 dtex.

8. The rubber ply of claim 1 wherein the textile cords are made of Nylon 6,6.

9. The rubber ply of claim 1 wherein the distance between two adjacent pairs of textile cords (dp) ranges from 0.15 mm to 1.5 mm.

10. The rubber ply of claim 1 wherein the distance between two adjacent pairs of textile cords (dp) ranges from 0.2 mm to 1.0 mm.

11. The rubber ply of claim 1 wherein the distance between two parallel textile cords (di) within a pair of textile cords is smaller than 0.15 mm.

12. The rubber ply of claim 1 wherein the rubber ply is a rubber ply strip having one or more of: a width (w) ranging from 0.5 cm to 2 cm and a thickness (t) ranging from 0.4 mm to 2 mm.

13. The rubber ply of claim 11 wherein the rubber ply strip has one or more of: a width (w) ranging from 0.5 cm to 1.5 cm and a thickness (t) ranging from 0.5 mm to 1.5 mm.

14. The rubber ply of claim 1 wherein the rubber ply is an overlay ply strip.

15. The rubber ply of claim 1 wherein the ratio of rubber to textile cords by weight ranges from 2.3:1 to 1.1:1.

16. The rubber ply of claim 1 wherein the ratio of rubber to textile cords by weight ranges from 2.0:1 to 1.5:1.

17. The rubber ply of claim 1 wherein each cord ply has a plurality of filaments.

18. A tire comprising two spaced apart bead portions, a tread portion, a pair of sidewalls extending from axially outer edges of the tread portion to join the respective bead portions, a carcass, at least one belt ply covering the carcass, and an overlay ply strip spirally arranged in a circumferential plane between the tread and the at least one belt ply, wherein the cords are arranged essentially in parallel to the length of the strip, wherein at least one of the belt ply and the overlay ply is comprised of a rubber ply comprising pairs of textile cords arranged in parallel in a plane, each cord of a pair of textile cords comprising two cord plies, wherein the distance between two adjacent pairs of textile cords (dp) is at least 5 times larger than the distance between two parallel textile cords within a pair of textile cords (di), and wherein the two cord plies in one or more of the textile cords are twisted together in a range from 8 twists per inch to 12 twists per inch and have each a density ranging from 500 dtex to 2000 dtex.

19. The tire of claim 18 wherein the strip is arranged at an angle ranging from 0° to 5° with respect to the equatorial plane (EP) of the tire.

20. The tire of claim 19 wherein the at least one belt ply comprises a textile cord reinforcement.
